(19) United States
(12) Patent Application Publication
(10) Pub. No.: US 2026/0163735 A1
(43) Pub. Date: Jun. 11, 2026

(54) MAPPING SERVICE FOR USER IDENTITIES

(71) Applicant: INTERNATIONAL BUSINESS MACHINES CORPORATION, ARMONK, NY (US)

(72) Inventors: ENRIQUE LANDER SANCHEZ-BIEZMA, Isleworth (GB); Raquel Margarita Katigbak, Rome (IT); Vishal Anand, Dublin (IE); Christopher Hay, Great Horkesley (GB); Jeffrey Castellano, New York, NY (US); Jennifer M. Hatfield, Portland, OR (US); Mary Wallace, Burnley (GB); Charbak Chatterjee, Kolkata (IN)

(21) Appl. No.: 19/044,655

(22) Filed: Feb. 4, 2025

(30) Foreign Application Priority Data
Dec. 5, 2024 (GB) 2417855.0

(51) Int. Cl. H04L 9/32

(52) U.S. Cl. CPC H04L 9/3213

(57) ABSTRACT

A method, computer program product, and computer system for providing an avatar mapping service for user identities in a metaverse. The method includes generating an avatar metadata file in the form of a data interchange file format and the avatar metadata file including mappings between avatars provided in different file formats and including references to any avatar resources associated with the provided avatars. The method further includes generating an identity token for a user referencing the avatar metadata file for use across different metaverse platforms as an identity authentication.

### BACKGROUND

The present disclosure relates to an avatar mapping service, and more specifically, to an avatar mapping service for mapping avatars to a user identity for use in the metaverse.

In computing, an avatar is a graphical representation of a user or persona. An avatar can take the form of a three-dimensional model to be used in online or virtual worlds, video games, video calls, etc. Avatars are the virtual identity for participants in the metaverse. Avatars are themselves units of value and a key lever for unlocking economies in virtual spaces.

Avatars in themselves are growing in population and are a key personalization tool. Social media platforms are implementing a range of avatar features that lead to increased use of avatars on these platforms. Enterprises are also promoting more virtual and immersive experiences with their members and clients.

Users gain access to a variety of metaverse platforms and ecosystems, ranging from decentralized platforms, to product-based spatial relationship platforms, and open metaverse platforms and applications. To access these metaverse platforms, users can authenticate themselves using digital wallets. Metaverse platforms typically offer a convenient single sign-on capability, allowing users to seamlessly connect with their digital wallets.

Within each of these platforms, users have the ability to create and utilize their own avatars, leveraging the supported 3D format conventions. Today's digital asset identity frameworks have a wide range of formats and do not allow a single identity to interoperate across the metaverse and decentralized applications. Customers are therefore forced to create new identities to align on different metaverse and decentralized application formats. This leads to a problem of online security where a real-life identity of a person interacting in a metaverse platform or application is not known or verified.

The current growth of metaverse platforms and applications is leading to an abundance of 3D formats (such as gITF, gLB, fBX, sTL, OBJ, etc.). However, no standardized format exists, resulting in a fragmented expansion of metaverse applications.

As a result, users are faced with the challenge of migrating avatars across various formats, each with different polygon counts, scales, models, performance capabilities, collisions, controls, and other potential issues.

Consequently, users are compelled to create new avatars for each application, leading to multiple identities spread across the metaverse. This lack of interoperability prevents users from seamlessly sharing and operating across different metaverse applications using a single identity and provides security concerns where multiple online identities are created without any real-life verification process.

### SUMMARY

According to an aspect of the present disclosure there is provided a computer-implemented method for providing an avatar mapping service for user identities in a metaverse, the method comprising: generating an avatar metadata file in the form of a data interchange file format and the avatar metadata file including mappings between avatars provided in different file formats and including references to any avatar resources associated with the provided avatars; and generating an identity token for a user referencing the avatar metadata file for use across different metaverse platforms as an identity authentication.

The user identity token may be used across platforms in the metaverse, including decentralized platforms, product-based spatial relationship platforms, open metaverse platforms and applications, enterprise platforms, etc. This has the advantage of providing interoperability for access to platforms across Web1, Web2, and Web3 platforms.

The identity token may be an identity non-fungible token (NFT) generated by a smart contract by which a user can authenticate themselves using a digital wallet. A user may authenticate themselves as a single online user identity using the digital wallet. The digital wallet may be provided in a separate independent authenticating user device to a device used to access a metadata platform or application.

The avatar mapping service has the advantage of providing a single identity for a user that is anchored on a digital identity token that maps multiple avatar formats to provide a single decentralized identity concept with the ability to present avatars in different media formats depending on the type of platform and applications being used. The avatar mapping service providing a single identity across different platforms and applications ensures increased security based on identify authentication of a user. Linking multiple avatars in the form of identity representations suitable for different platforms, ensures that an avatar can be authenticated as belonging to a known and verified identity of a user.

According to another aspect of the present disclosure there is provided a system for providing an avatar mapping service for user identities in a metaverse, comprising: a processor and a memory configured to provide computer program instructions to the processor to execute a method of: generating an avatar metadata file in the form of a data interchange file format and the avatar metadata file including mappings between avatars provided in different file formats and including references to any avatar resources associated with the provided avatars; and generating an identity token for a user referencing the avatar metadata file for use across different metaverse platforms as an identity authentication.

According to another aspect of the present disclosure there is provided a computer program product for providing an avatar mapping service for user identities in a metaverse, the computer program product comprising a computer readable storage medium having program instructions embodied therewith, the program instructions executable by a processor to cause the processor to: generate an avatar metadata file in the form of a data interchange file format and the avatar metadata file including mappings between avatars provided in different file formats and including references to any avatar resources associated with the provided avatars; and generate an identity token for a user referencing the avatar metadata file for use across different metaverse platforms as an identity authentication.

The computer readable storage medium may be a non-transitory computer readable storage medium and the computer readable program code may be executable by a processing circuit.

The present disclosure seeks to provide one or more concepts of mapping avatars to a user identity for security in the metaverse. Such concepts may be computer-implemented. That is, such methods may be implemented in a computer infrastructure having computer executable code tangibly embodied on a computer readable storage medium having programming instructions configured to perform a proposed method. The present disclosure further seeks to provide a computer program product including computer program code for implementing the proposed concepts when executed on a processor.

The above summary is not intended to describe each illustrated embodiment or every implementation of the present disclosure.

### BRIEF DESCRIPTION OF THE DRAWINGS

Embodiments of the present disclosure will now be described, by way of example only, with reference to the accompanying drawings:

FIG. 1 is a flow diagram of an example embodiment of a method in accordance with aspects of the present disclosure;

FIG. 2 is a flow diagram of an example embodiment of a method in accordance with aspects of the present disclosure;

FIG. 3 is a schematic diagram of an example embodiment of aspects of the described method;

FIG. 4 is a block diagram of an example embodiment of an overall system in accordance with embodiments of the present disclosure; and

FIG. 5 is a block diagram of an example embodiment of a system in accordance with embodiments of the present disclosure; and

FIG. 6 is a block diagram of an example embodiment of a computing environment for the execution of at least some of the computer code involved in performing aspects of the present disclosure.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numbers may be repeated among the figures to indicate corresponding or analogous features.

### DETAILED DESCRIPTION

Embodiments of a method, system, and computer program product are described for providing an avatar mapping service for user identities in the metaverse. The avatar mapping service supports generating an avatar metadata file in the form of a data interchange file format. The avatar metadata file includes mappings between avatars provided in different file formats and including references to the avatar resources of the different file formats. The avatar file formats may be three-dimensional (3D) graphics file formats. This provides a metadata language for the mapping. The avatar mapping service supports referencing the avatar metadata file when generating an identity token for a user for use across different metaverse platforms as a single identity authentication.

The identity token may be a Non-Fungible Token (NFT) that is a unique digital identifier that is recorded on a blockchain or other form of digital identity token that can be used to certify ownership and authenticity. The user identity may be used across platforms in the metaverse, including decentralized platforms, product-based spatial relationship platforms, open metaverse platforms and applications, enterprise platforms, etc.

The avatar mapping service provides a single identity for a user that is anchored on a digital identity token that maps multiple avatar formats to provide a single decentralized identity concept with the ability to present avatars in different media formats depending on the type of platform and applications being used.

The avatar mapping service takes the concept of single sign-on to the next level by enabling users to go beyond simple wallet authentication and provide an identity token federated with the wallet, which allows the presentation of the appropriate avatar format for the specific metaverse platform. This enables a user to access different metaverse spaces using a single identity token but with different avatars that are aligned for given context and intent. The avatars may be provided within a specified time dimension.

The avatar mapping service is an improvement in the technical field of computer security generally and more particularly in the technical field of user identity security in online systems.

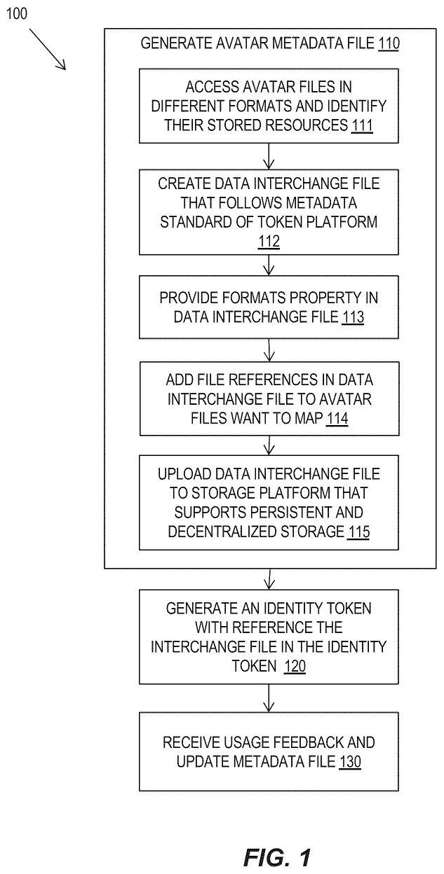

Referring to FIG. 1, a flow diagram 100 shows an example embodiment of an aspect of the described method of providing an avatar mapping.

The method generates 110 an avatar metadata file in the form of a data interchange file format and the avatar metadata file including mappings between avatars provided in different file formats and including references to any avatar resources associated with the provided avatars. The method of generating 110 an avatar metadata file may include the following steps. These steps may be carried out in a different order to that shown in the figure.

The method may access 111 avatar files in different file formats and may identify their stored resources, for example, leveraging 3D format conventions. The avatar files may be avatars that a user already uses, or new avatars being created for a metaverse platform. The method may include storing the avatar resources (such as digital files and artworks) of the different formats on trusted distributed file sharing services to provide availability and integrity of the avatar resources for use in metaverse platforms.

The method may create 112 a data interchange file format that follows a metadata standard for a token platform that is to be used. For example, in the case of an NFT, this may be an NFT metadata JavaScript Object Notation (JSON) file format linked to the NFT. The method may provide 113 a formats property in the avatar metadata file in the form of an array containing objects for each avatar file format. Each object may have a type property indicating the file format. The method may also add 114 additional properties pointing to references for avatar resources for the format.

The method may upload 115 and store the avatar metadata file in the form of a data interchange file to a storage platform that supports persistent and decentralized storage.

The method generates 120 an identity token for a user referencing the avatar metadata file for use across different metaverse platforms as an identity authentication. The identity token may be an NFT generated by a smart contract by which a user can authenticate themselves using a digital wallet. This provides increased online security as a single identity for a user can be authenticated across multiple metaverse platforms and applications.

In this way, multiple avatar file formats are dynamically manifested within the identity token using the avatar metadata file to improve the compatibility and accessibility for users and platforms interacting with the identity token. This allows multiple avatar file formats to be included within the same token metadata, which can improve compatibility, accessibility and verification for users and platforms interacting with the identity token.

The method may receive 130 usage feedback of the identity token and may update the avatar metadata file including reconstructing the avatar mapping. This may result in updating the identity token including providing a secondary token associated with the original identity token.

A polymorphic avatar generation may be used to reconstruct the avatar mapping and provide an updated identity token. This may predict a next target metaverse platform and may generate multiple avatars in a plurality of persona for the same user that is contextual to such predicted target metaverse platform and attached to the updated identity token via the mapping service. Conditioning data may be gathered from a target metaverse platform and run through a method of polymorphic avatar generation to predict and identify a user preferred avatar for an in-context metaverse platform utilizing the mapping service and historical usage data to present the identity token with a specific avatar format to the in-context metaverse platform.

User behavior may be reflected on the reconstruction of the avatar mapping and subsequent updated identity token, across the preferred metaverse platforms over time. The avatar may map to multiple metaverse platforms and adapts to the user behavior across the time. Over a period of time, the proposed method acquires feedback through a feedback-loop, that may be processed through a function of usage-token metadata-intent on scale of time, to reconstruct the avatar mapping and generate an updated token.

There may be a primary identity token used for access to the different platforms. In order to make the avatar interoperable with other platforms, the primary token may be used to create a secondary token with the target platform while lifecycle of this new secondary token will be still controlled by the primary token. This may be referred to as a primary controller. This may include migrating an identity token to a secondary token that contains a plurality of avatar formats optimized with bounded context of a target system while a control-pane resides within proposed system and wherein a token contract originator regulates the lifecycle of the secondary token.

Based on the usage pattern within specific a time dimension, the avatar mapping with the identity token may change and may be persisted through the metadata language. This may contextually change the mapping of avatars with an associated centralized identity token using metadata language for in-context temporal sessions. This may be a function of user usage pattern, image, and avatar metadata in over time.

The method provides an intelligent dynamic presentation of user identity as a Universal User identity (UUid) adaptable to Web1/Web2/Web3 platforms. The UUid is in the form of an identity token with associated avatars associated with specific target platforms. This provides Web1, Web2, Web3 interoperability for access to platforms.

To deliver coherent experience, the avatars are contextually aware on user intent. The method manages the lifecycle of the identity including but not limited auto-tagging, anonymization, and reconstruction of the identity based on the user usage/action feedback loop.

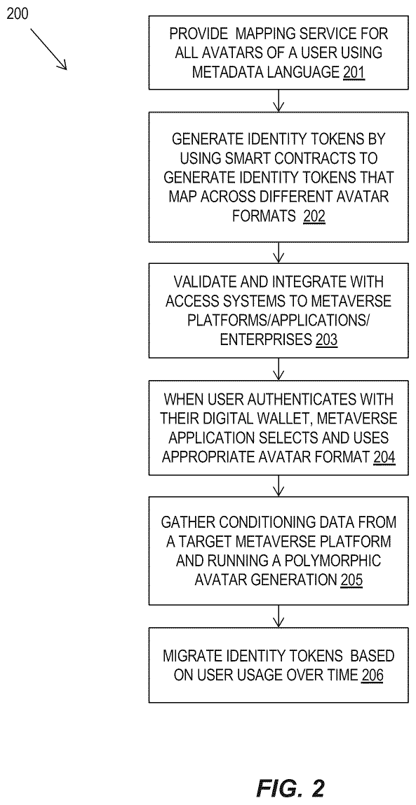

Referring to FIG. 2, a flow diagram 200 shows an example embodiment of another aspect of the described method of mapping avatars.

The method provides 201 the mapping service for all avatars of a user using a metadata language as explained above.

The method may generate 202 identity tokens that map across different avatar formats. The identity tokens may be NFTs and may utilize smart contracts to generate and govern the unique NFTs.

To use the identity token as a single and trusted identity mechanism, the method validates and integrates 203 with different metaverse platforms and applications to seamlessly connect with various metaverse platforms and applications and to ensure the smooth presentation of the user's avatar via the token. The metaverse platforms may include enterprise or metaverse identity and access management services.

Consequently, when a user authenticates with their digital wallet, a metaverse application automatically selects and utilizes 204 the appropriate avatar format. This significantly enhances the overall user experience and increases the online security within the metaverse environment.

The method may dynamically present to a metaverse platform of an appropriate avatar file for the platform and associated with the identity token by using the avatar metadata file including references to avatar resources of different formats.

The method may gather 205 conditioning data from a target metaverse platform and may run a polymorphic avatar generation to predict and identify a preferred avatar for the target metaverse platform.

The method may migrate 206 and update identity tokens based on usage over time.

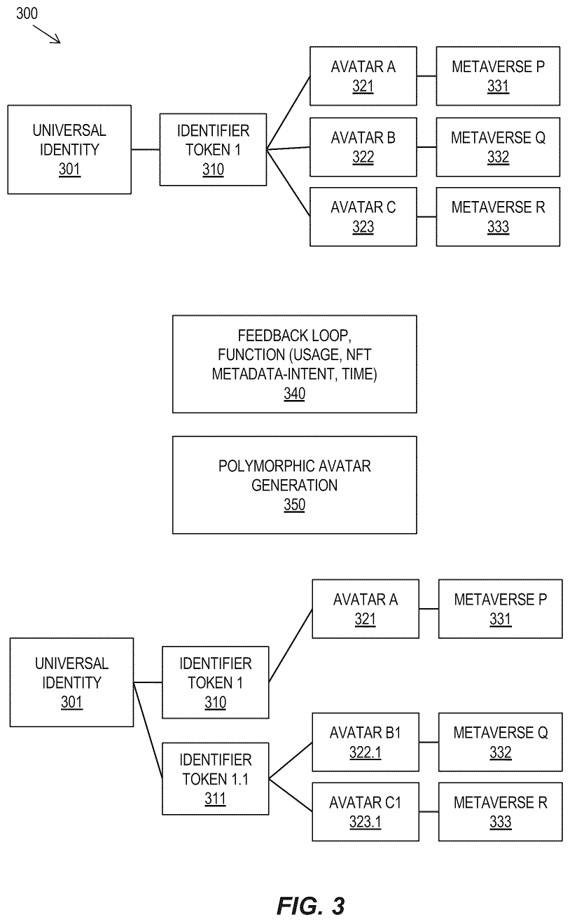

Referring to FIG. 3, a schematic diagram 300 illustrates the use of identifier tokens with avatar mappings as described herein.

A user may have a universal identity 301 in the form of a digital wallet and may have an identification token 1 310 as described herein that references mapping metadata to map multiple avatar files A 321, B 322, C 323 for their respective metaverse platforms P 331, Q 332, R 333. User can now access different metaverse spaces using the single token 310 but with different avatar 321, 322, 323 that are aligned for given context and intent within specified time dimensions.

Over a period of time, a feedback loop 340 acquires experience that is processed through a function of usage-token metadata-intent on scale of time and reconstructs the avatar mapping along with a new token if required for a new experience.

A polymorphic avatar generation 350 may be used to re-construct the avatar mapping and provide a new secondary token 1.1 311.

In this example, the universal identity 301 is then linked to the identifier token 1 310 and a secondary token 1.1 311. The original identifier token 1 310 is provided with a metadata file mapping for avatar A 321 for metaverse P 331. The secondary identifier token 1.1 311 is provided with a metadata file mapping for updated avatar B1 322.1 for metaverse Q 332 and updated avatar C1 323.1 for metaverse R 333400.

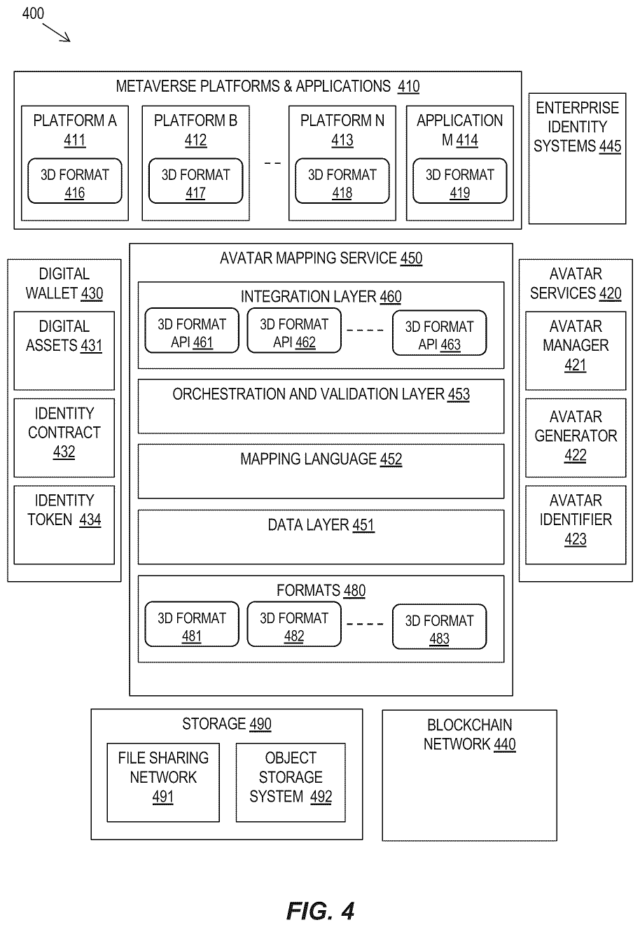

Referring to FIG. 4, a block diagram shows an overall environment 400 for avatar mapping as described herein.

The environment 400 may include a variety of metaverse platforms and applications 410, 411-414, ranging from decentralized platforms to product-based platforms, and open metaverse platforms and applications to which a user may gain access.

Within each of these platforms and applications, users have the ability to create and utilize their own avatars, leveraging the supported 3D format conventions 416-419 that may vary between platforms and applications 411-414.

Avatar services 420 may be provided including avatar manager 421, an avatar generator 422, and an avatar identifier 423. A blockchain network 440 may be provided for the digital wallet 430 having digital assets 431.

To access the metaverse platforms 410, users can authenticate themselves using digital wallets 430 such as Web3 wallets. Metaverse platforms 410 typically offer a convenient single sign-on capability, allowing users to seamlessly connect with their digital wallets 430.

An avatar mapping service 450 is provided as described herein that enables users to go beyond simple wallet authentication by authenticating with an identity token 434, such as an NFT, federated with the wallet identity via an identity contract 432, which allows the presentation of the appropriate avatar format 480, 481-483 for the specific metaverse platform or application 411-415. The avatar mapping service 450 includes an integration layer 460 including application programming interfaces 461-463 for the supported avatar formats 480, 481-483.

The avatar mapping service 450 includes a data layer 451, a mapping language 452, and an orchestration and validation layer 453 for providing the described functionality.

The mapping language 452 maps different avatars and formats across metaverse platforms using a unique language. The mapping language 452 allows a dynamic understanding of the specific type of avatar that is required of a particular request where this requires complex system integration between avatar formats and traditional identity and access management systems.

Integrating enterprise identity and access management systems 445 with an identity token 434 makes it more difficult to gain unauthorised access to sensitive enterprise resources or to impersonate other enterprise users within the virtual world.

The avatar mapping service 450 may use storage 490 including a file sharing network 491 and object storage systems 492 that may be decentralized and persistent for storing avatar resources and avatar metadata files.

The avatar mapping service 450 securely stores the token artwork, including avatar formats on trusted file sharing services such as InterPlanetary File System (IPFS) services. This ensures the availability and integrity of the avatar assets for use in the metaverse.

Once a user has successfully authenticated with their wallet 430, the avatar mapping service 450 may provide advanced avatar mapping capabilities, allowing users to seamlessly authenticate with an identity token 434 and present the appropriate avatar format 481-483 for the specific metaverse platform 411-414.

The avatar mapping service 450 constructs a mapping service using a token metadata language. The avatar mapping service 450 enables seamless translation and presentation of avatars across different metaverse platforms.

These features collectively enhance the user's interaction with the metaverse by providing advanced avatar mapping capabilities, personalized experiences, and simplified access to multiple metaverse platforms using a single authentication process.

The following is an example embodiment of how the avatar mapping may work in a data interchange file format.

In this example, the “formats” property is an array containing objects for each avatar file format. Each object has a “type” property, indicating the file format, and properties like “model” and “texture” that point to the corresponding files using URLs or IPFS hashes. This allows multiple avatar file formats to be included within the same NFT metadata, which can improve compatibility and accessibility for users and platforms interacting with the avatar NFT.

The following is pseudo code

{

“name”: “My Multi-Format Avatar NFT”,

| | |
|---|---|
| “description”: | “A description of the avatar's unique attributes across multiple...”, |
| “image”: | “ipfs://QmSomeHash12345/avatar_thumbnail.png”, |
| “formats”: | [ |
| | { |
| | “type”: “VRML” |
| | “model”: ipfs://QmSomeHash12345/avatar_model.wrl” |
| | } |
| | { |
| | “type”: “X3D” |
| | “model”: ipfs://QmSomeHash12345/avatar_model.x3d” |
| | } |
| | { |
| | “type”: “FBX” |
| | “model”: ipfs://QmSomeHash12345/avatar_model.fbx” |
| | } |
| | { |
| | “type”: “OBJ” |
| | “model”: ipfs://QmSomeHash12345/avatar_model.obj” |
| | “texture”: ipfs://QmSomeHash12345/avatar_texture.mtl” |
| | } |
| | { |
| | “type”: “GLB” |
| | “model”: ipfs://QmSomeHash12345/avatar_model.glb” |
| | } |

]
“attributes”: [

```
{
  “trait_type”: “Rarity”,
  “value”: “Rare”
},
{
  “trait_type”: “Color”,
  “value”: “Blue”
}
```

]

}
{
“type”: “OBJ”
“model”: ipfs://QmSomeHash12345/avatar_model.obj”
“texture”: ipfs://QmSomeHash12345/avatar_texture.mtl”
}
{
“type”: “GLB”
“model”: ipfs://QmSomeHash12345/avatar_model.glb”
}

]
“attributes”: [

```
{
  “trait_type”: “Rarity”,
  “value”: “Rare”
},
{
  “trait_type”: “Color”,
  “value”: “Blue”
}
```

]

}

The following is an example implementation using NFTs and JSON to map files.

NFT metadata is an important aspect of NFTs, as it provides a standardized way to store additional information about the NFT, such as its description, name, image, and other attributes. The metadata is usually stored in a JSON file, which is a widely used format for exchanging and storing structured data.

To map files using NFT metadata JSON, the following steps may be taken.

A JSON file is created that follows the metadata standard specified by the NFT platform being used. These standards usually require certain properties like “name,” “description,” and “image.”

In the JSON file, references are included to the files to map, such as images, videos, or 3D models. The references may use Uniform Resource Locators (URL)s or InterPlanetary File System (IPFS) hashes as references to these files. For example, it might include an “image” property with a URL or IPFS hash pointing to the image file associated with the NFT.

The JSON file is uploaded to a storage platform that supports persistent and decentralized storage, like IPFS. This ensures that the metadata remains accessible even if the original server goes down.

The metadata is referenced in the NFT. When minting the NFT on the blockchain, a reference to the JSON metadata file is included in the token's contract. This is usually done by providing the URL or IPFS hash of the JSON file as part of the token Uniform Resource Identifier (URI) or similar property in the NFT contract.

By following these steps, the NFT metadata JSON is used to map files associated with the NFTs, making it easier for users to access and understand the additional information and resources related to the token.

They utilize avatars in various ways, such as logging into virtual worlds to engage in brainstorming sessions with colleagues, recruiting new employees, interacting with customers for sales purposes, participating in leadership training, managing programs, overseeing operational centers, and collaborating with company groups globally.

This integration with enterprise identity and access management systems ensures that avatars are associated with the appropriate user identities, allowing for seamless authentication, authorization, and access control.

The rationale behind this trend is rooted in the advantages of virtual interactions: it is more convenient, cost-effective, environmentally friendly, and promotes well-being compared to traditional in-person meetings.

This asset highlights our unique value to accelerate the development and interoperability for an open metaverse helping our clients unlock new value and monetization streams from virtual identities.

The described methods and system address the problems of multiple avatar formats, and the difficulties associated with the existence of various forms, standards, and technologies used for creating, rendering, and sharing digital avatars across different platforms and applications.

The incompatibility of different avatar formats is removed allowing users to transfer their avatars between platforms. This removes the fragmentation previously encountered by the presence of multiple avatar formats. The user experience is improved as they are able to transfer their avatars seamlessly between platforms. Dealing with multiple avatar formats previously created barriers for new users entering the Web3 ecosystem. The complexity and effort required to manage avatars deters users from trying new platforms or applications, slowing down the growth and adoption of Web3 applications.

Interoperability between platforms and applications encourages the seamless sharing and utilization of avatars across the digital landscape. This removes limitations on social interactions and collaborative experiences in virtual environments.

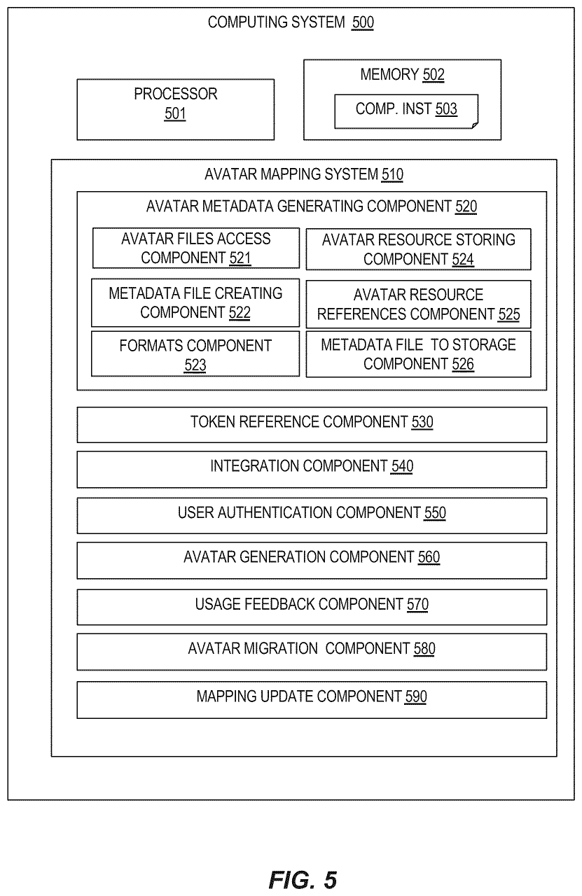

Referring to FIG. 5, a block diagram shows a computing system 500 in which an avatar mapping system 510 may be provided. The computing system 500 may include at least one processor 501, a hardware module, or a circuit for executing the functions of the described components which may be software units executing on the at least one processor. Multiple processors running parallel processing threads may be provided enabling parallel processing of some or all of the functions of the components. Memory 502 may be configured to provide computer instructions 503 to the at least one processor 501 to carry out the functionality of the components.

The avatar mapping system 510 may include an avatar metadata generating component 520 for generating an avatar metadata file in the form of a data interchange file format and the avatar metadata file including mappings between avatars provided in different formats and including references to the avatar resources of the different formats.

The avatar metadata generating component 520 may include an avatar files access component 521 for accessing avatar files in different file formats and may identify their stored resources, for example, leveraging 3D format conventions.

The avatar metadata generating component 520 may include a metadata file creating component 522 for creating a data interchange file that follows a metadata standard for a token platform that is to be used.

The avatar metadata generating component 520 may include a formats component 523 for providing a formats property in the avatar metadata file in the form of an array containing objects for each avatar file format, wherein each object has a type property indicating the file format and additional properties pointing to references for avatar resources for the format.

The avatar metadata generating component 520 may include an avatar resource storing component 524 for storing the avatar resources of the different formats on trusted distributed file sharing services to provide availability and integrity of the avatar resources for use in metaverse platforms.

The avatar metadata generating component 520 may include an avatar resource component 525 for providing references in the metadata file to the avatar resources.

The avatar metadata generating component 520 may include a metadata file storage component 526 for storing the avatar metadata file in the form of a data interchange file to a storage platform that supports persistent and decentralized storage.

The avatar mapping system 510 may include a token referencing component 530 for referencing the avatar metadata file when generating an identity token for a user for use across different metaverse platforms as an identity authentication.

The avatar mapping system 510 may include an integration component 540 for providing integration with different metaverse platforms and applications including presentation of a user's avatar in the identity token with a reference to a compatible format avatar resource.

The avatar mapping system 510 may include a user authentication component 550 for providing a service for a user authentication in multiple metaverse platforms with avatar mapping capabilities using the identify token having a reference to the avatar metadata file.

The avatar mapping service 510 may include an avatar generation component 560 for gathering conditioning data from a target metaverse platform and running a polymorphic avatar generation to predict and identify a preferred avatar for the target metaverse platform.

The avatar mapping service 510 may include a usage feedback component 570 for obtaining feedback and an avatar migration component 580 for migrating an identity token to a secondary token that contains a plurality of avatar formats optimized with bounded context of a target system.

The avatar mapping service 510 may include a mapping update component 590 for contextually changing a mapping of an avatar associated with the identity token for an in-context session (temporal) and persisted form based on algorithms which function of user usage pattern, image and avatar metadata in purview of time.

By way of example:
Avatars can be AI and Generative AI based Avatars powered by language models or machine learning algorithms;
Avatar persona can be a set of functions and toolsets of Agentic AI in the system;
Avatars can be a set of multi-modal Avatars;
Avatars can process multi-modal inputs and multi-modal outputs;
Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

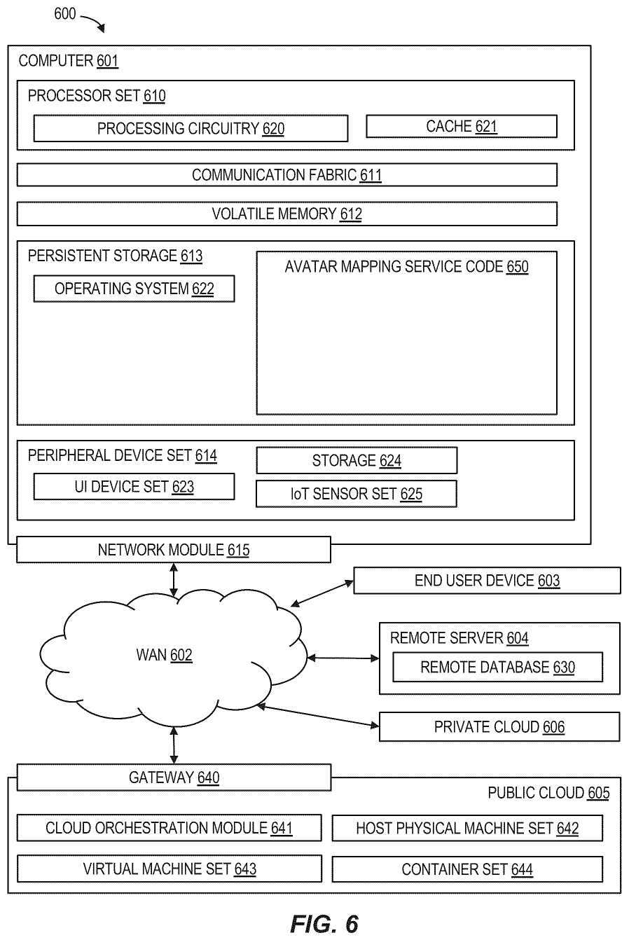

Referring to FIG. 6, computing environment 600 contains an example of an environment for the execution of at least some of the computer code involved in performing the inventive methods, such as avatar mapping service code 650. In addition to block 650, computing environment 600 includes, for example, computer 601, wide area network (WAN) 602, end user device (EUD) 603, remote server 604, public cloud 605, and private cloud 606. In this embodiment, computer 601 includes processor set 610 (including processing circuitry 620 and cache 621), communication fabric 611, volatile memory 612, persistent storage 613 (including operating system 622 and block 650, as identified above), peripheral device set 614 (including user interface (UI) device set 623, storage 624, and Internet of Things (IoT) sensor set 625), and network module 615. Remote server 604 includes remote database 630. Public cloud 605 includes gateway 640, cloud orchestration module 641, host physical machine set 642, virtual machine set 643, and container set 644.

COMPUTER 601 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 630. As is well understood in the art of computer technology, and depending upon the technology, performance of a computer-implemented method may be distributed among multiple computers and/or between multiple locations. On the other hand, in this presentation of computing environment 600, detailed discussion is focused on a single computer, specifically computer 601, to keep the presentation as simple as possible. Computer 601 may be located in a cloud, even though it is not shown in a cloud in FIG. 6. On the other hand, computer 601 is not required to be in a cloud except to any extent as may be affirmatively indicated.

PROCESSOR SET 610 includes one, or more, computer processors of any type now known or to be developed in the future. Processing circuitry 620 may be distributed over multiple packages, for example, multiple, coordinated integrated circuit chips. Processing circuitry 620 may implement multiple processor threads and/or multiple processor cores. Cache 621 is memory that is located in the processor chip package(s) and is typically used for data or code that should be available for rapid access by the threads or cores running on processor set 610. Cache memories are typically organized into multiple levels depending upon relative proximity to the processing circuitry. Alternatively, some, or all, of the cache for the processor set may be located “off chip.” In some computing environments, processor set 610 may be designed for working with qubits and performing quantum computing.

Computer readable program instructions are typically loaded onto computer 601 to cause a series of operational steps to be performed by processor set 610 of computer 601 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 621 and the other storage media discussed below. The program instructions, and associated data, are accessed by processor set 610 to control and direct performance of the inventive methods. In computing environment 600, at least some of the instructions for performing the inventive methods may be stored in block 650 in persistent storage 613.

COMMUNICATION FABRIC 611 is the signal conduction path that allows the various components of computer 601 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 612 is any type of volatile memory now known or to be developed in the future. Examples include dynamic type random access memory (RAM) or static type RAM. Typically, volatile memory 612 is characterized by random access, but this is not required unless affirmatively indicated. In computer 601, the volatile memory 612 is located in a single package and is internal to computer 601, but, alternatively or additionally, the volatile memory may be distributed over multiple packages and/or located externally with respect to computer 601.

PERSISTENT STORAGE 613 is any form of non-volatile storage for computers that is now known or to be developed in the future. The non-volatility of this storage means that the stored data is maintained regardless of whether power is being supplied to computer 601 and/or directly to persistent storage 613. Persistent storage 613 may be a read only memory (ROM), but typically at least a portion of the persistent storage allows writing of data, deletion of data and re-writing of data. Some familiar forms of persistent storage include magnetic disks and solid state storage devices. Operating system 622 may take several forms, such as various known proprietary operating systems or open source Portable Operating System Interface-type operating systems that employ a kernel. The code included in block 650 typically includes at least some of the computer code involved in performing the inventive methods.

PERIPHERAL DEVICE SET 614 includes the set of peripheral devices of computer 601. Data communication connections between the peripheral devices and the other components of computer 601 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 623 may include components such as a display screen, speaker, microphone, wearable devices (such as goggles and smart watches), keyboard, mouse, printer, touchpad, game controllers, and haptic devices. Storage 624 is external storage, such as an external hard drive, or insertable storage, such as an SD card. Storage 624 may be persistent and/or volatile. In some embodiments, storage 624 may take the form of a quantum computing storage device for storing data in the form of qubits. In embodiments where computer 601 is required to have a large amount of storage (for example, where computer 601 locally stores and manages a large database) then this storage may be provided by peripheral storage devices designed for storing very large amounts of data, such as a storage area network (SAN) that is shared by multiple, geographically distributed computers. IoT sensor set 625 is made up of sensors that can be used in Internet of Things applications. For example, one sensor may be a thermometer and another sensor may be a motion detector.

NETWORK MODULE 615 is the collection of computer software, hardware, and firmware that allows computer 601 to communicate with other computers through WAN 602. Network module 615 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 615 are performed on the same physical hardware device. In other embodiments (for example, embodiments that utilize software-defined networking (SDN)), the control functions and the forwarding functions of network module 615 are performed on physically separate devices, such that the control functions manage several different network hardware devices. Computer readable program instructions for performing the inventive methods can typically be downloaded to computer 601 from an external computer or external storage device through a network adapter card or network interface included in network module 615.

WAN 602 is any wide area network (for example, the internet) capable of communicating computer data over non-local distances by any technology for communicating computer data, now known or to be developed in the future. In some embodiments, the WAN 602 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 603 is any computer system that is used and controlled by an end user (for example, a customer of an enterprise that operates computer 601), and may take any of the forms discussed above in connection with computer 601. EUD 603 typically receives helpful and useful data from the operations of computer 601. For example, in a hypothetical case where computer 601 is designed to provide a recommendation to an end user, this recommendation would typically be communicated from network module 615 of computer 601 through WAN 602 to EUD 603. In this way, EUD 603 can display, or otherwise present, the recommendation to an end user. In some embodiments, EUD 603 may be a client device, such as thin client, heavy client, mainframe computer, desktop computer and so on.

REMOTE SERVER 604 is any computer system that serves at least some data and/or functionality to computer 601. Remote server 604 may be controlled and used by the same entity that operates computer 601. Remote server 604 represents the machine(s) that collect and store helpful and useful data for use by other computers, such as computer 601. For example, in a hypothetical case where computer 601 is designed and programmed to provide a recommendation based on historical data, then this historical data may be provided to computer 601 from remote database 630 of remote server 604.

PUBLIC CLOUD 605 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 605 is performed by the computer hardware and/or software of cloud orchestration module 641. The computing resources provided by public cloud 605 are typically implemented by virtual computing environments that run on various computers making up the computers of host physical machine set 642, which is the universe of physical computers in and/or available to public cloud 605. The virtual computing environments (VCEs) typically take the form of virtual machines from virtual machine set 643 and/or containers from container set 644. It is understood that these VCEs may be stored as images and may be transferred among and between the various physical machine hosts, either as images or after instantiation of the VCE. Cloud orchestration module 641 manages the transfer and storage of images, deploys new instantiations of VCEs and manages active instantiations of VCE deployments. Gateway 640 is the collection of computer software, hardware, and firmware that allows public cloud 605 to communicate through WAN 602.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 606 is similar to public cloud 605, except that the computing resources are only available for use by a single enterprise. While private cloud 606 is depicted as being in communication with WAN 602, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 605 and private cloud 606 are both part of a larger hybrid cloud.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Improvements and modifications can be made to the foregoing without departing from the scope of the present invention.

What is claimed is:

1. A computer-implemented method for providing an avatar mapping service for user identities in a metaverse, the method comprising:
generating an avatar metadata file in a data interchange file format, the avatar metadata file including mappings between avatars provided in different file formats and including references to avatar resources associated with the provided avatars; and
generating an identity token for a user referencing the avatar metadata file for use across different metaverse platforms as an identity authentication.

2. The method of claim 1, wherein the identity token is an identity non-fungible token (NFT) generated by a smart contract by which a user can authenticate themselves using a digital wallet.

3. The method of claim 1, wherein generating the avatar metadata file comprises:
providing a formats property in the avatar metadata file in an array containing objects for each avatar file format, wherein each object has a type property indicating the file format and additional properties pointing to references for avatar resources for the format.

4. The method of claim 1, further comprising:
storing the avatar metadata file in the form of a data interchange file in persistent and decentralized storage.

5. The method of claim 1, further comprising:
storing avatar resources of the different formats on trusted distributed file sharing services to provide availability and integrity of the avatar resources for use in metaverse platforms.

6. The method of claim 1, further comprising:
providing integration with different metaverse platforms and applications including presentation of a user's avatar in the identity token with a reference to a compatible format avatar resource.

7. The method of claim 1, further comprising:
providing a service for a user authentication in multiple metaverse platforms with avatar mapping capabilities using the identity token having a reference to the avatar metadata file.

8. The method of claim 1, further comprising:
generating multiple avatar files in different formats;
creating the avatar metadata file for an NFT platform;
adding references for avatar resources in the different formats to the avatar metadata file;
uploading the avatar metadata file to persistent and decentralized storage; and
referencing the avatar metadata file in an identity NFT created on the NFT platform.

9. The method of claim 1, further comprising:
gathering conditioning data from a target metaverse platform and running a polymorphic avatar generation to predict and identify a preferred avatar for the target metaverse platform.

10. The method of claim 1, further comprising:
dynamically presenting to a metaverse platform of an appropriate avatar file for the platform and associated with the identity token by using the avatar metadata file including references to avatar resources of different formats.

11. The method of claim 1, further comprising:
using a primary identity token to create a secondary token operable for a target platform with a lifecycle of the secondary token controlled by the primary token.

12. The method of claim 1, further comprising:
contextually changing a mapping of an avatar associated with the identity token based on a usage pattern within a time dimension and persisted through the metadata file language.

13. A system for providing an avatar mapping service for user identities in a metaverse, the system comprising:
a processor and a memory configured to provide computer program instructions to the processor to execute a method comprising:
generating an avatar metadata file in a data interchange file format and the avatar metadata file including mappings between avatars provided in different file formats and including references to any avatar resources associated with the provided avatars; and
generating an identity token for a user referencing the avatar metadata file for use across different metaverse platforms as an identity authentication.

14. The system of claim 13, wherein the generating the avatar metadata file comprises:
providing a formats property in the avatar metadata file in an array containing objects for each avatar file format, wherein each object has a type property indicating the file format and additional properties pointing to references for avatar resources for the format.

15. The system of claim 13, wherein the method further comprises:
storing the avatar metadata file in the form of a data interchange file in persistent and decentralized storage.

16. The system of claim 13, wherein the method further comprises:
storing any avatar resources of the different formats on trusted distributed file sharing services to provide availability and integrity of the avatar resources for use in metaverse platforms.

17. The system of claim 13, wherein the method further comprises:
providing integration with different metaverse platforms and applications including presentation of a user's avatar in the identity token with a reference to a compatible format avatar resource.

18. The system of claim 13, wherein the method further comprises:
providing a service for a user authentication in multiple metaverse platforms with avatar mapping capabilities using the identity token having a reference to the avatar metadata file.

19. The system of claim 13, wherein the method further comprises:
contextually changing a mapping of an avatar associated with the identity token for a session based user usage pattern, image and avatar metadata over time.

20. A computer program product comprising a computer readable medium having program instructions embodied therein, the program instructions executable by a processor to cause the processor to perform a method comprising:
generating an avatar metadata file in a data interchange file format, the avatar metadata file including mappings between avatars provided in different file formats and including references to avatar resources associated with the provided avatars; and
generating an identity token for a user referencing the avatar metadata file for use across different metaverse platforms as an identity authentication.
